(19) United States
(12) Patent Application Publication
(10) Pub. No.: US 2023/0419009 A1
(43) Pub. Date: Dec. 28, 2023

(54) COMPUTER-IMPLEMENTED METHOD FOR SIMULATING AN ELECTRICAL CIRCUIT BY MEANS OF A REAL-TIME PLATFORM

(71) Applicant: dSPACE GmbH, Paderborn (DE)

(72) Inventor: Johann MATIX, Paderborn (DE)

(73) Assignee: dSPACE GmbH, Paderborn (DE)

(21) Appl. No.: 18/212,368

(22) Filed: Jun. 21, 2023

(30) Foreign Application Priority Data
Jun. 22, 2022 (DE) 10 2022 115 570.6

(51) Int. Cl. G06F 30/3308

(52) U.S. Cl. CPC G06F 30/3308; G06F 2111/10

(57) ABSTRACT

A method for simulating an electrical circuit via a real-time platform on the basis of a behavioral model in nodal form with an impedance matrix M or a topology-oriented behavioral model in state space with the matrices A, B, C, and D, and at least one impedance matrix M describing a circuit or at least one set for the matrices A, B, C, and D describing the circuit is stored on the real-time platform for this purpose. Thus, a more efficient sequence of operations is achieved as a result.

This nonprovisional application claims priority under 35 U.S.C. § 119(a) to German Patent Application No. 10 2022 115 570.6, which was filed in Germany on Jun. 22, 2022, and which is herein incorporated by reference.

### BACKGROUND OF THE INVENTION

### Field of the Invention

The present invention relates to a computer-implemented method for simulating an electrical circuit by means of a real-time platform, wherein the simulation of the electrical circuit takes place on the real-time platform under a real-time operating system on the basis of a behavioral model in nodal form with an impedance matrix M or by means of a topology-oriented behavioral model in state space with the matrices A, B, C, and D, and at least one impedance matrix M describing the electrical circuit to be simulated or at least one set for the matrices A, B, C, and D describing the electrical circuit to be simulated is stored on the real-time platform for this purpose.

### Description of the Background Art

The invention is thus in the technical field of real-time simulation of electrical circuits for the purpose of influencing or testing a technical/physical process. The technical/physical process can involve procedures on control units, such as are used, for example, in motor vehicles, airplanes, and power generation or power distribution systems. The technical/physical process can also involve the frequency converter of an electric drive, a DC/DC converter, an electricity supply network, or any controlled machine components—particularly from automation technology—that are controlled by the simulated electrical circuit. Two use cases, in particular, come into consideration here, namely hardware-in-the-loop (HIL) simulations on the one hand and rapid control prototyping (RCP) on the other hand.

The computing unit by means of which the required simulation is carried out in this case is often part of an HIL simulator or a real-time-capable RCP computer, which customarily is intended to replace a control unit. Such a computing unit can be referred to hereinbelow as a real-time platform. Such a real-time platform is distinguished by the fact that a real-time operating system runs on it.

An operating system undertakes the management of the hardware resources of a computer, and functions as host for the applications that are executed on the computer. Precisely these tasks are also undertaken by a real-time operating system. In addition, however, a real-time operating system can also execute applications that require very exact timing.

A real-time operating system can thus be understood to be an operating system that is capable of executing a critical operation over a restricted period of time. These operations include, for example, operating system calls and interrupt handling. A key factor is therefore that a real-time operating system with correct programming makes it possible to execute a program with extremely consistent timing. The operating systems typically used on PCs (such as Windows®) are general operating systems, not real-time operating systems. Operating systems such as Windows® allow user flexibility through numerous programs and services, whereas real-time operating systems are capable of executing critical applications reliably and with precise timing.

Both an HIL simulator and an RCP computer have an I/O interface through which electrical signals can be read in and/or output, wherein the electrical signals generally are analog or digital communications signals with low power. However, in the case of electrical loads or power amplifiers, substantial amounts of electric power, for example for driving electric motors, can also be transmitted through the I/O interface.

Consequently, selected calculated output quantities of the overall electrical circuit are output through the I/O interface as electrical signals so they can act on a technical/physical process. In addition, or alternatively, process quantities of the technical/physical process are measured and read in through the I/O interface in the form of electrical signals and provided to the real-time platform. As a result, the simulation has direct influence on the physical world.

The simulation of such circuits places great demands on the simulation hardware employed, which is to say on the computing units employed and their memory equipment, in particular for reasons including that the simulation must take place in real time since a real process is being influenced or quantities obtained from a real process through measurement are being processed as part of the simulation. The real-time platform can be different cores of a processor, but can also be different processors of a multi-processor system, which is frequently the case with larger HIL simulators. It is also possible that a real-time platform is implemented on the basis of one or more FPGAs (field programmable gate array).

It is known in the prior art to describe the circuits under discussion here by mathematical representations on the basis of physical laws. Through the formulation of mesh and node equations, such circuits can be mathematically represented, for example in nodal form with an impedance matrix M or through the definition of input and output quantities and state variables in state space with the matrices A, B, C, and D (topology-oriented behavioral model). With regard to this topology-oriented behavioral model, reference is made by way of example to DE 10 2019 130 971 A1 and to “The state-variable approach to network analysis,” by E. S. Kuh and R. A. Rohrer, in Proceedings of the IEEE, vol. 53, no. 7, pp. 672-686, July 1965, doi: 10.1109/PROC.1965.3991, and regarding the nodal form with an impedance matrix, reference is made to “Digital Computer Solutions of Electromagnetic Transients in Single- and Multiphase Networks,” by Hermann W. Dommel, IEEE Transactions on Power Apparatus and Systems, Vol. PAS-88, No. 4, April 1969.

If a parameter of a circuit is now to be changed, in other words if, for example, the load resistance of a circuit is to be changed in accordance with a load curve that is part of the simulation, this is not easily possible at the run time of the simulation because this value appears as a factor at multiple points of the impedance matrix M describing the electrical circuit or the matrices A, B, C, and D. Instead, the impedance matrix M or the matrices A, B, C, and D must be recalculated for the new resistance value. Until now, it has been necessary to test, prior to the simulation on the real-time platform, which values the parameters could assume, so the matrices were effectively calculated and stockpiled in advance.

When there are multiple parameters, this can result in very large memory requirements owing to the multitude of possible combinations. If it should then be determined during the simulation that a parameter value nonetheless is not present because it was not calculated in advance, it was heretofore necessary to stop the simulation, separately calculate the appropriate value and add it to the simulation, and then set up the simulation again and restart it from the beginning. This is very costly and time-intensive.

### SUMMARY OF THE INVENTION

It is therefore an object of the present invention to provide a more efficient sequence of operations.

According to an exemplary embodiment of the invention, a computer-implemented method is provided for simulating an electrical circuit by means of a real-time platform, wherein the simulation of the electrical circuit takes place on the real-time platform under a real-time operating system on the basis of a behavioral model in nodal form with an impedance matrix M or by means of a topology-oriented behavioral model in state space with the matrices A, B, C, and D, and at least one impedance matrix M describing the electrical circuit to be simulated or at least one set for the matrices A, B, C, and D describing the electrical circuit to be simulated is stored on the real-time platform for this purpose, wherein the method has the following steps: executing the behavioral model for the electrical circuit on the real-time platform, wherein the behavioral model has a controller that sets parameters of the simulation as a function of the current simulation and sends a calculation request regarding the calculation of the impedance matrix M or the matrices A, B, C, and D to a computer connected to the real-time platform when it is determined that no associated impedance matrix M or no associated matrices A, B, C, and D are stored on the real-time platform for a parameter value to be set; receiving the calculation request on the computer connected to the real-time platform and performing the requested calculation of the impedance matrix M or the matrices A, B, C, and D on the computer; transmitting the calculated impedance matrix M or the calculated matrices A, B, C, and D from the computer to the real-time platform; and using the impedance matrix M calculated on the computer or the matrices A, B, C, and D calculated on the computer in the simulation on the real-time platform.

The invention thereby makes it possible that no concrete parameter values must be defined before the simulation. Instead, they can be determined during the simulation. As a result, different load curves can be followed or different operating points can be tested, for example, without the need to stop the simulation and set it up again.

In addition, a major aspect of the invention is that the simulation can continue to run on the real-time platform during the calculation of the impedance matrix M or the matrices A, B, C, and D on the computer, since the matrix calculation is offloaded from the real-time platform. In the absence of such an offloading, a separate software routine would have to be created for the real-time platform in order to perform the matrix calculation, and furthermore, the matrix calculation would potentially demand so much computing power that the simulation would be adversely affected or would have to be interrupted. However, it is generally very difficult, if not completely impossible, to interrupt a simulation running on a real-time platform under a real-time operating system, so the offloading of the matrix calculation to the computer makes it possible at all to take into account changes in parameters of the circuit simulated on the real-time platform during ongoing operation of the real-time system.

The computer can be operated with a different operating system from the real-time operating system of the real-time platform. It is very especially preferred here that the operating system of the computer is not a real-time operating system. Thus, it is possible for the computer to operate with, for example, the Windows® operating system, which in turn makes it possible to use standard programs running under Windows® for matrix calculation, such as MATLAB®/Simulink®. A creation of separate software routines for calculating the matrices can be avoided as a result.

The parameter value to be set can be an electrical characteristic of a component of the electrical circuit, such as a resistance value.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a flowchart for a computer-implemented method for simulating an electrical circuit by means of a real-time platform according to an example, and

FIG. 2 schematically shows a real-time platform and a computer that is separate therefrom according to an example.

### DETAILED DESCRIPTION

In a simulation of an electrical circuit on a real-time platform, if the value of, e.g., a load resistance of the circuit is to be changed at run time in accordance with a load curve that is part of the simulation, this has hitherto not been easily possible because this value is present as a factor at multiple points in the matrices describing the circuit in the state space of a topology-oriented behavioral model. For this reason, according to the invention the matrices for the new resistance value are recalculated on the basis of the topology of the electrical circuit by a computer that is separate from the real-time platform.

In the event that the calculation of complex data is necessary during a real-time simulation on a real-time platform, it is therefore the case according to the present invention that this calculation is offloaded from the real-time platform to an external computer on which appropriate programs, such as MATLAB®/Simulink®, are available that are not present on the real-time platform. Provision is thus made within the scope of the invention that a behavioral model running on the real-time platform for simulating an electrical circuit makes a calculation request at run time with the transfer of parameter values to the separate computer from the real-time platform, and the computer subsequently carries out the calculation and transmits the calculated data to the real-time platform so that these data are available there for the further simulation.

For the simulation of electrical circuits in the program Simscape Electrical®, which likewise is installed on the computer, the topology-oriented behavioral model in state space is—as is well known—represented as follows:

dx/dt=Ax+Bu

y=Cx+Du

Here, u(t) is the input signal, y(t) is the output signal, and A, B, C, and D are the matrices describing the circuit in state space.

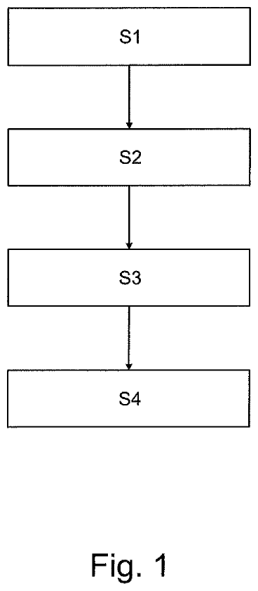

In this regard, a flowchart for a computer-implemented method for simulating an electrical circuit by means of a real-time platform according to a preferred exemplary embodiment of the invention is now shown in FIG. 1. As already addressed, the simulation of an electrical circuit on the basis of a behavioral model by means of a topology-oriented behavioral model in state space with matrices A, B, C, and D takes place on the real-time platform under a real-time operating system, wherein a set describing the electrical circuit to be simulated is stored for the matrices A, B, C, and D on the real-time platform for this purpose.

In a first step S1, a behavioral model for the electrical circuit is executed on the real-time platform. In this context, the behavioral model has a controller that sets parameters of the simulation as a function of the current simulation. In addition, when it is determined that no associated matrices A, B, C, and D for a parameter value to be set are stored on the real-time platform, the controller sends a calculation request regarding the calculation of the matrices A, B, C, and D by means of a rising edge to a computer connected to the real-time platform and running under Windows®. The corresponding data are forwarded by a driver to corresponding trace variables. The trace variables can be read from or written to the computer by means of a program installed on the computer, such as the ControlDesk® program from the applicant. Communication between the real-time platform and the computer is possible in this way. The ControlDesk® program is experimental software by the applicant for control unit development. This program offers access to simulation platforms, such as to the present real-time platform 1, and connected bus systems, and can carry out measurement, application, and diagnostic tasks on control units, for example through standardized ASAM interfaces.

In step S2, this calculation request is received on the computer connected to the real-time platform, and the requested calculation of the matrices A, B, C, and D is performed on the computer. On the computer, the trace variables are monitored by ControlDesk® or directly by XIL API. Upon detection of the calculation request, the calculation allowing for the parameters is started. In the present case, this calculation is the calculation in MATLAB® of the coefficients of the state space of the given electrical circuit for different resistance values. To this end, a Python function is executed that sets the new resistance value in the Simscape Electrical® behavioral model in MATLAB®/Simulink® and then executes the MATLAB® “power_analyze” function, which analyzes the circuit and returns the new matrices.

After that, in step S3, the calculated matrices A, B, C, and D are transmitted from the computer to the real-time platform by means of trace variables.

Finally, in step S4, the matrices A, B, C, and D that were calculated on the computer are used in the simulation on the real-time platform.

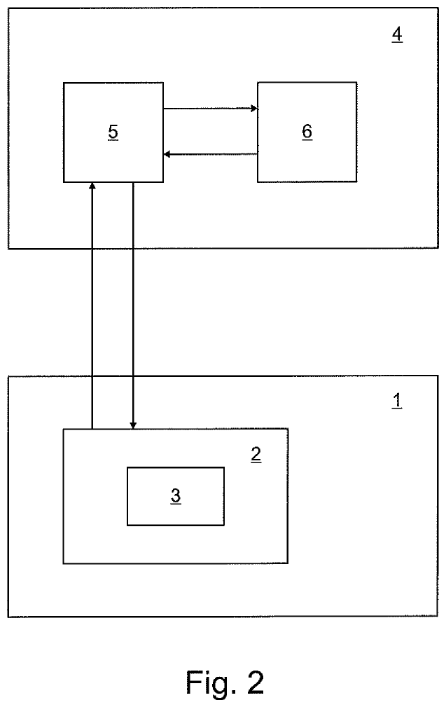

This sequence is again represented schematically in FIG. 2. The real-time platform 1 has a processor 2, on which the real-time operating system runs. In addition, the real-time platform can also have an FPGA. The behavioral model 3 is executed on this real-time operating system for simulation of the electrical circuit. Provided separately from the real-time platform 1 is the computer 4, which runs under Windows®. The programs ControlDesk® 5 and MATLAB® 6 are installed on this computer 4.

As is shown with an arrow leading from the processor 2 of the real-time platform 1 to the program ControlDesk® 5, the calculation request in question is made to the computer 4. The program ControlDesk® 5 reads the trace variables transmitted for this purpose and thereupon issues a corresponding calculation order to the program MATLAB® 6, which is likewise shown with an arrow. As is shown with another arrow, after the calculation the program MATLAB® 6 returns the result of the calculation to the program ControlDesk® 5. The program ControlDesk® 5 then writes the corresponding trace variables and a download of the result, likewise shown with an arrow, takes place from the computer 4 to the processor 2 of the real-time platform 1, where the result is now available for the further simulation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for simulating an electrical circuit via a real-time platform, the simulation of the electrical circuits taking place on the real-time platform under a real-time operating system based on a behavioral model in nodal form with an impedance matrix M or a topology-oriented behavioral model in a state space with matrices A, B, C, and D, at least one impedance matrix M describing the electrical circuit to be simulated or at least one set for the matrices A, B, C, and D describing the electrical circuit to be simulated is stored on the real-time platform for this purpose, the method comprising:
executing the behavioral model for the electrical circuit on the real-time platform, the behavioral model having a controller that sets parameters of the simulation as a function of the current simulation and sends a calculation request regarding the calculation of the impedance matrix M or the matrices A, B, C, and D to a computer connected to the real-time platform when it is determined that no associated impedance matrix M or no associated matrices A, B, C, or D are stored on the real-time platform for a parameter value to be set;
receiving the calculation request on the computer connected to the real-time platform and performing the requested calculation of the impedance matrix M or the matrices A, B, C, and D on the computer;
transmitting the calculated impedance matrix M or the calculated matrices A, B, C, and D from the computer to the real-time platform; and
using the impedance matrix M calculated on the computer or the matrices A, B, C, and D calculated on the computer in the simulation on the real-time platform.

2. The method according to claim 1, wherein the computer is operated with a different operating system from the real-time operating system of the real-time platform.

3. The method according to claim 2, wherein the operating system of the computer is not a real-time operating system.

4. The method according to claim 1, wherein the simulation continues to run on the real-time platform during the calculation of the impedance matrix M or the matrices A, B, C, and D on the computer.

5. The method according to claim 1, wherein the parameter value to be set is an electrical characteristic of a component of the electrical circuit.
